(19) United States
(12) Patent Application Publication
(10) Pub. No.: US 2026/0225616 A1
(43) Pub. Date: Aug. 6, 2026

(54) NEARBY VEHICLE BLIND SPOT MONITORING SYSTEM CAPABILITY DETECTION

(71) Applicant: Toyota Motor Engineering & Manufacturing North America, Inc., Plano, TX (US)

(72) Inventors: Benjamin Piya Austin, Saline, MI (US); Joshua E. Domeyer, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/046,877

(22) Filed: Feb. 6, 2025

(51) Int. Cl. B60W 60/00; B60W 50/14

(52) U.S. Cl. CPC B60W 60/0015; B60W 50/14

(57) ABSTRACT

Systems, methods, and other embodiments described herein relate to guiding ego vehicles around nearby vehicles based on the driver assistance systems present in the nearby vehicle. In one embodiment, a method includes capturing perception data from an environment sensor of an ego vehicle. The environment sensor perceives objects in an area surrounding the ego vehicle. The method also includes extracting, from the perception data, a blind spot monitoring (BSM) capability of a nearby vehicle. The method also includes generating a control signal for the ego vehicle based on the BSM capability of the nearby vehicle. The control signal alters an operation of a driver assistance system of the ego vehicle.

### TECHNICAL FIELD

The subject matter described herein relates, in general, to driver assistance systems and, more particularly, to detecting, in an ego vehicle, the blind spot monitoring capability of a nearby vehicle and taking appropriate countermeasures.

### BACKGROUND

Congestion on vehicle roadways across the globe is becoming increasingly heavy. Roadway navigation has inherent dangers, and the number of motorists and other road users increases the danger on roadways. That is to say, the number of roadways across the globe and the number of vehicles on those roadways is increasing, which leads to an increased risk of vehicle collision and/or passenger injury. This is exacerbated by the technological development of vehicles, which, in some cases, provide automated rather than manual vehicle control.

Vehicles may be equipped with driver assistance systems that promote the safe navigation of roadways. There are various driver assistance systems, such as lane-keeping systems, lane change alert systems, automatic cruise control systems, and display interfaces that provide notifications to the vehicle driver.

In general, the further awareness vehicles have about a surrounding environment, the better a driver can be supplemented with information to assist in driving, and/or the better an autonomous system can control the vehicle to avoid hazards.

### SUMMARY

In one embodiment, example systems and methods relate to a manner of improving vehicle driver assistance systems, particularly by augmenting driver assistance system operations based on the detected blind spot monitoring (BSM) capability of a nearby vehicle.

In one embodiment, a blind spot monitoring (BSM) detection system for detecting the BSM capability of a nearby vehicle is disclosed. The BSM detection system includes a processor and a memory storing machine-readable instructions. The memory stores machine-readable instructions that, when executed by the processor, cause the processor to capture perception data from an environment sensor of an ego vehicle. The environment sensor perceives objects in an area surrounding the ego vehicle. The memory also includes machine-readable instructions that, when executed by the processor, cause the processor to extract, from the perception data, a BSM capability of a nearby vehicle. The memory also includes instructions that, when executed by the processor, cause the processor to generate a control signal for an ego vehicle based on the BSM capability of the nearby vehicle. The control signal alters an operation of a driver assistance system of the ego vehicle.

In one embodiment, a non-transitory computer-readable medium for detecting the BSM capability of a nearby vehicle is disclosed. The instructions include instructions to capture perception data from an environment sensor of an ego vehicle. The environment sensor perceives objects in an area surrounding the ego vehicle. The instructions also include instructions that, when executed by the processor, cause the processor to extract, from the perception data, a BSM capability of a nearby vehicle. The instructions also include instructions that, when executed by the processor, cause the processor to generate a control signal for an ego vehicle based on the BSM capability of the nearby vehicle. The control signal alters an operation of a driver assistance system of the ego vehicle.

In one embodiment, a method for detecting the BSM capability of a nearby vehicle is disclosed. In one embodiment, the method includes capturing perception data from an environment sensor of an ego vehicle. The environment sensor perceives objects in an area surrounding the ego vehicle. The method also includes extracting, from the perception data, a BSM capability of a nearby vehicle. The method also includes generating a control signal for an ego vehicle based on the BSM capability of the nearby vehicle. The control signal alters an operation of a driver assistance system of the ego vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a BSM detection system that is associated with detecting the BSM capability of a nearby vehicle.

FIG. 3 illustrates one embodiment of a BSM detection system that is associated with detecting the BSM capability of a nearby vehicle.

FIG. 4 illustrates a flowchart for one embodiment of a method that is associated with detecting the BSM capability of a nearby vehicle.

FIG. 5 illustrates a notification that indicates the BSM capability of a nearby vehicle.

FIG. 6 illustrates the BSM detection system altering the movement of an ego vehicle based on the BSM capability of a nearby vehicle.

FIG. 7 illustrates the BSM detection system altering the movement of an ego vehicle based on the BSM capability of a nearby vehicle.

FIG. 8 illustrates a BSM detection system detecting the BSM capability of a nearby vehicle.

FIG. 9 illustrates a flowchart for one embodiment of a method that is associated with detecting the BSM capability of a nearby vehicle.

### DETAILED DESCRIPTION

Systems, methods, and other embodiments associated with improving driver assistance systems are disclosed herein. As previously described, roadway travel has inherent dangers exacerbated by the increasing number of motorists. Vehicles may be equipped with driver assistance systems that help them navigate these roadways more safely. There are various types of driver assistance systems with varying degrees of intervention. For example, a driver assistance system may notify a driver of a nearby object that poses a danger to the motorist. Specifically, a vehicle may be equipped with sensors that perceive the surrounding environment and present a notification to the driver of the vehicle of the detected object. Other driver assistance systems may at least partially take control of the vehicle. For example, a lane-keeping system may control a vehicle steering system to maintain a vehicle within a designated lane on a road. As yet another example, an automatic cruise control system may control the speed and longitudinal position of a vehicle to maintain a predetermined minimal distance between other vehicles. While particular reference is made to particular driver assistance systems, a vehicle may be equipped with any number of these or other driver assistance systems, such as a lane change alert system.

One particular example of a driver assistance system is a blind spot monitoring (BSM) system. There may be regions around a vehicle that are difficult for a driver to see, even with the aid of mirrors. That is to say, a driver's field of view may extend approximately 180 degrees in front of them, a rear-view mirror may provide a field of view behind the driver, and side-view mirrors may provide a field of view to either side of the driver. However, there may be gaps between these fields of view, in particular between the field of view of a rear-view mirror and the fields of view of side-view mirrors. These gap regions may be referred to as blind spots and can be the cause of roadway accidents. For example, a driver may attempt to change lanes. Even while safely checking their surroundings, a nearby vehicle may be positioned in a blind spot of the driver. As such, the driver may execute a lane change, either colliding with the nearby vehicle or causing the driver and/or the nearby vehicle driver to react suddenly upon realizing the situation.

A BSM system reduces the likelihood of a potential collision that may result when one vehicle is in the blind spot of the driver of another vehicle. A BSM system includes various sensors such as cameras, LiDAR sensors, radar sensors, sonar sensors, millimeter wave (mm-wave) radars, and the like that depict the surrounding environment, including vehicles in the blind spot of the vehicle. A BSM indicator provides a visual, audible, or haptic cue to the driver of the ego vehicle attempting a maneuver toward a blind spot where a nearby vehicle is detected. The BSM indicator may take a variety of forms, including an illuminated icon on the side-view mirror of a vehicle.

While the BSM system and other driver assistance systems increase driving safety, some inherent risks remain. For example, not all vehicles are equipped with BSM systems. As another example, a BSM system may malfunction (e.g., by not detecting nearby objects and/or not providing a notification to a vehicle driver). This frustrates the purpose of the BSM system and may introduce new sources of danger. That is, a driver may operate the ego vehicle in a fashion that assumes the nearby vehicle has a BSM system, for example, by exercising a certain amount of caution, assuming that the nearby vehicle's BSM system will be aware of the ego vehicle, even when in a blind spot. However, if the nearby vehicle does not have a BSM system or has a malfunctioning BSM system, greater caution may be warranted on the part of the ego vehicle driver. That is to say, by incorrectly assuming that the nearby vehicle has a properly functioning BSM system, the ego vehicle driver may be exercising less caution than the situation would dictate.

Accordingly, the present system 1) determines whether a nearby vehicle has an active and functioning BSM system and 2) adjusts ego vehicle operation based on the capabilities of the nearby vehicle's BSM system (e.g., whether or not the nearby vehicle has a BSM system and whether the BSM system is functioning correctly). The present system does so without relying on a vehicle-to-vehicle communications network, as the nearby vehicle may not be a connected vehicle capable of transmitting BSM system capability/state information. Specifically, the present system on an ego vehicle relies on captured perception data, such as from cameras, infrared cameras, LiDAR sensors, radar sensors, and the like, to detect either a BSM sensor or a BSM indicator on the nearby vehicle. In one particular example, the BSM detection system identifies an active BSM system by identifying the illumination activity of a BSM indicator on the body of the nearby vehicle.

Based on this received information, the BSM detection system may take any number of remedial actions based on the determined capability of the nearby vehicle BSM system. In one example, the remedial measure is the presentation of a notification to the ego vehicle driver through any number of output systems, such as a graphic user interface (GUI) on an infotainment system or a speaker system of the ego vehicle. In another example, the system may control the operation of the ego vehicle to either increase/ensure the visibility of the ego vehicle to the nearby vehicle driver or reduce the amount of time that the ego vehicle is within the blind spot of the nearby vehicle. For example, the system may generate control signals that direct the vehicle systems to perform lateral movement along the roadway to increase the visibility of the ego vehicle and/or increase the speed of the ego vehicle during takeover to reduce the duration that the ego vehicle is in the blind spot of the nearby vehicle.

In one particular example, the BSM detection system may localize data analysis to those regions of the nearby vehicle where a BSM sensor or indicator may be found. That is, each vehicle may have predetermined locations where a BSM sensor and/or indicator is located, which location information may be stored locally at the ego vehicle or in a remotely-stored vehicle record. In this example, the BSM detection system may, based on perception data, identify the type of vehicle (for example, by make, model, and year) and determine, based on the vehicle record, 1) if the vehicle has BSM capability and 2) the location of the BSM sensors and indicators. A processor of the BSM detection system can then focus data analysis on those regions of the perception data that correspond to the location of the BSM sensors and indicators identified in the vehicle records.

In this way, the disclosed systems, methods, and other embodiments improve vehicle driver assistance systems. For example, the present system expands the capability of driver assistance systems by providing new detection functionality by detecting whether a nearby vehicle has an active and functioning BSM detection system. In particular, the BSM detection is a non-communications-based system that does not rely on the nearby and ego vehicle sharing a communications network. As described above, such a BSM detection system responds to a potential risk that may previously have gone undetected, that of an ego vehicle driver incorrectly assuming a nearby vehicle driver is cognizant of their presence. Accordingly, the current BSM detection system increases the breadth of protection offered by driver assistance systems and increases vehicle operation safety.

The current system also enhances driver assistance system operation by introducing a new vehicle control trigger (e.g., whether or not the nearby vehicle has blind spot sensing capability), new sensing capabilities (e.g., sensing whether the nearby vehicle has BSM sensors and indicators), and a new control paradigm (e.g., generating notifications and altering vehicle operation based on the BSM capability of a nearby vehicle). Still further, the present system alters the feedback systems of the ego vehicle by providing new feedback modalities, specifically those that indicate the BSM status of nearby vehicles, where previously, vehicle BSM state-based notifications may not be implemented.

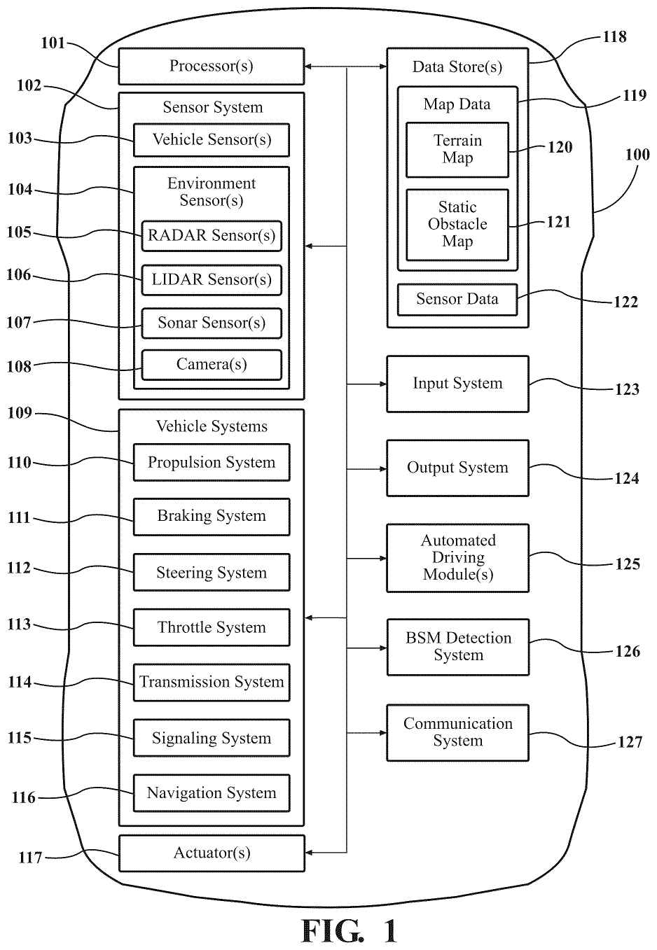

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with detecting and responding to a nearby vehicle's BSM capability.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

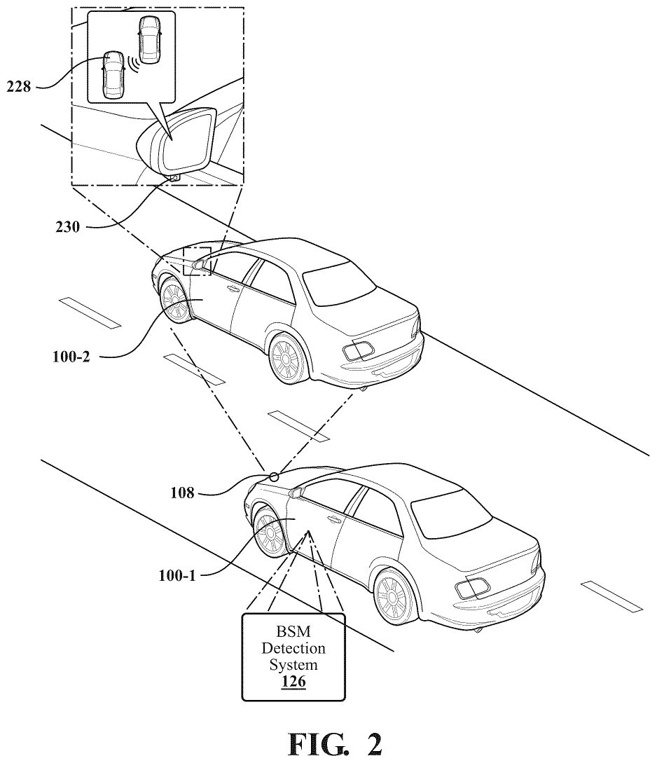

Some of the possible elements of the vehicle 100 are shown in FIG. 1 and will be described along with subsequent figures. However, a description of many of the elements in FIG. 1 will be provided after the discussion of FIGS. 2-9 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a BSM detection system 126 that is implemented to perform methods and other functions as disclosed herein relating to improving driver assistance systems.

FIG. 2 illustrates a BSM detection system 126 detecting the BSM capability of a nearby vehicle 100-2. Specifically, FIG. 2 depicts an ego vehicle 100-1 attempting a takeover maneuver of a nearby vehicle 100-2. Both the ego vehicle 100-1 and the nearby vehicle 100-2 may be an example of the vehicle 100 depicted in FIG. 1. As described above, it may be that the nearby vehicle 100-2 is a non-BSM type vehicle or that a BSM system of the nearby vehicle 100-2 is malfunctioning. The present BSM detection system 126 allows the ego vehicle 100-1 to detect the presence and state of the nearby vehicle BSM system and alter the operation of the ego vehicle 100-1 accordingly. Specifically, if the nearby vehicle 100-2 is a non-BSM type vehicle or has a malfunctioning BSM system, the ego vehicle 100-1 may take a number of countermeasures to ensure safe navigation around the nearby vehicle 100-2.

As described, the ego vehicle 100-1 may be equipped with a variety of environment sensors 104, including but not limited to an outwardly-facing camera 108. The outwardly-facing camera 108 and other environment sensors 104 perceive objects surrounding the ego vehicle 100-1, including the nearby vehicle 100-2. The perception data from the environment sensor 104 (e.g., the outwardly-facing camera 108) is captured and stored in a data store of the ego vehicle 100-1. From this perception data, the BSM detection system 126 extracts a BSM capability of the nearby vehicle 100-2.

A BSM system has various physical components, which may be on the exterior body of the nearby vehicle 100-2. Specifically, the BSM system may include a BSM sensor 230 to detect objects (e.g., the ego vehicle 100-1) in the nearby vehicle 100-2 blind spot. The BSM sensor 230 may be of a variety of types, including a camera, a LiDAR sensor, a radar sensor, a sonar sensor, and the like. In one particular example, a BSM sensor 230 may be disposed, for example, under a side-view mirror of the nearby vehicle 100-2. Note that while FIG. 2 depicts a single BSM sensor 230 in a particular physical location, the BSM system of the nearby vehicle 100-2 may include various BSM sensors 230 in various locations on the nearby vehicle 100-2, each of which may be captured and identified in the environment sensor 104 output. That is, the BSM detection system 126 may include a machine vision system or image processor that detects objects in the environment sensor output. Accordingly, the BSM detection system 126 may identify the BSM sensor 230 in captured images or other output, which identification indicates the BSM capability of the nearby vehicle 100-2. If the BSM detection system 126 does not identify a BSM sensor 230 (nor a BSM indicator 228), the BSM detection system 126 may determine that the vehicle is a non-BSM type vehicle.

Another component of the BSM system is a BSM indicator 228 that notifies the driver of the nearby vehicle 100-2 of an object in the blind spot. As an example, the BSM indicator 228 may be a light on a side-view mirror of the nearby vehicle 100-2. When an object is detected in the blind spot, the BSM indicator 228 may illuminate and/or flash. In some cases, the BSM indicator 228 illuminates responsive to the nearby vehicle 100-2 attempting a maneuver toward the blind spot. In either case, when an object is not detected, the BSM indicator 228 may be inactive (i.e., not illuminated). When inactive, the BSM indicator 228 may have a distinct physical appearance from the rest of the side-view mirror. Note that while FIG. 2 depicts a single BSM indicator 228 in a particular physical location, the BSM system of the nearby vehicle 100-2 may include various BSM indicators 228 in various locations on the nearby vehicle 100-2 and within the nearby vehicle 100-2, such as on the instrument panel of the nearby vehicle 100-2.

Each instance of a BSM indicator 228 may be captured and identified in the environment sensor 104 output. That is, the BSM detection system 126 may include a machine vision system or image processor that detects objects in the environment sensor output. Accordingly, the BSM detection system 126 may identify the BSM indicator 228 in captured images or other output, which identification indicates the BSM capability of the nearby vehicle 100-2. If the BSM detection system 126 does not identify the BSM indicator 228 (nor a BSM sensor 230), the BSM detection system 126 may determine that the vehicle is a non-BSM type vehicle.

Once the BSM capability of the nearby vehicle 100-2 is detected, the BSM detection system 126 may execute a number of remedial actions responsive to an indication that the nearby vehicle 100-2 is a non-BSM type vehicle or that the BSM system of the nearby vehicle 100-2 is malfunctioning. An example remedial action includes generating a visual, audible, and/or haptic notification in the cabin of the ego vehicle 100-1 that apprises the driver of the ego vehicle 100-1 of the BSM capability of the nearby vehicle 100-2. In one particular example, the BSM detection system 126 triggers autonomous control over the ego vehicle 100-1 and/or automatically alters the operation of the ego vehicle systems 109. For example, the BSM detection system 126 may generate a control signal that controls the steering system 112 to perform back-and-forth lateral movements. These back-and-forth movements may draw the attention of the driver of the nearby vehicle 100-2, such that the nearby vehicle driver becomes aware of the ego vehicle 100-1, notwithstanding the lack of a BSM system in the nearby vehicle 100-2. As another example, the BSM detection system 126 may generate a control signal that controls a propulsion system 110 and/or a throttle system 113 to increase the speed of the ego vehicle 100-1 as it passes the nearby vehicle 100-2, thus reducing the amount of time that the ego vehicle 100-1 is in the blind spot region of the nearby vehicle 100-2.

Accordingly, the BSM detection system 126 enhances driver assistance systems by providing functionality that may have previously been non-existent. Specifically, the BSM detection system 126 detects new conditions (i.e., a nearby vehicle's BSM capability) and provides new autonomous vehicle control and/or new notifications based on such. Thus, the BSM detection system 126 increases driver and road safety.

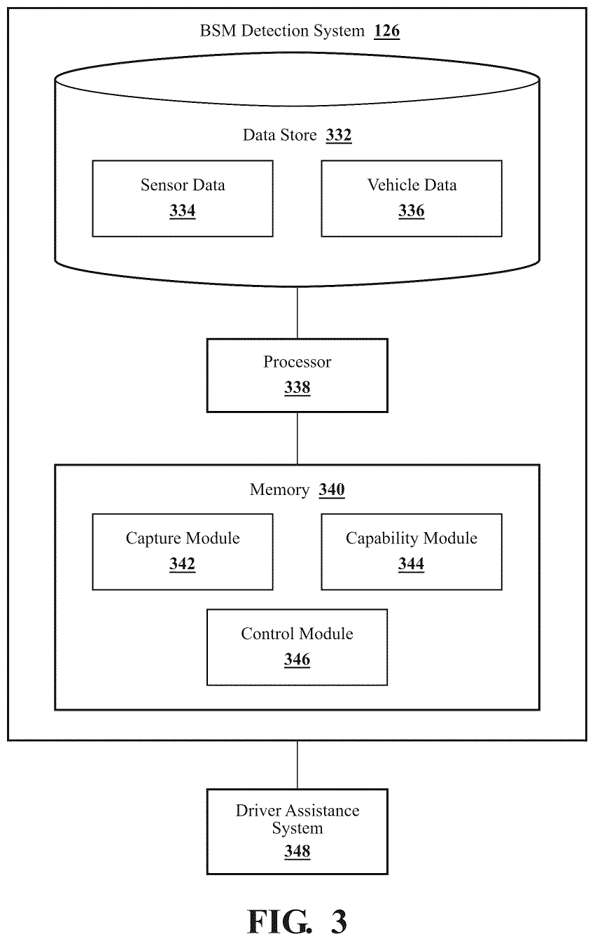

With reference to FIG. 3, one embodiment of the BSM detection system 126 of FIG. 1 is further illustrated. The BSM detection system 126 is shown as including a processor 338. The processor 338 may be the processor 101 from the vehicle 100 of FIG. 1. Accordingly, the processor 338 may be a part of the BSM detection system 126, the BSM detection system 126 may include a separate processor from the processor 101 of the vehicle 100, or the BSM detection system 126 may access the processor 101 through a data bus or another communication path that is separate from the vehicle 100. In one embodiment, the BSM detection system 126 includes a memory 340 that stores a capture module 342, a capability module 344, and a control module 346. The memory 340 is a random-access memory (RAM), read-only memory (ROM), a hard-disk drive, a flash memory, or another suitable memory for storing the modules 342, 344, and 346. The modules 342, 344, and 346 are, for example, computer-readable instructions that, when executed by the processor 338, cause the processor 338 to perform the various functions disclosed herein. In alternative arrangements, the modules 342, 344, and 346 are independent elements from the memory 340 that are, for example, comprised of hardware elements. Thus, the modules 342, 344, and 346 are alternatively application-specific integrated circuits (ASICs), hardware-based controllers, a composition of logic gates, or another hardware-based solution.

Moreover, in one embodiment, the BSM detection system 126 includes the data store 332. In an example, the data store 332 may be the data store 118 depicted in FIG. 1. In another example, the data store 332 is a separate data store from the data store 118 depicted in FIG. 1. The data store 332 is, in one embodiment, an electronic data structure stored in the memory 340 or another data storage device and that is configured with routines that can be executed by the processor 338 for analyzing stored data, providing stored data, organizing stored data, and so on. Thus, in one embodiment, the data store 332 stores data used by the modules 342, 344, and 346 in executing various functions.

The data store 332 stores sensor data 334, which, in one example, includes the sensor data 122 depicted in FIG. 1 or a portion thereof. In general, sensor data 334 is the data collected by the vehicle sensors 103 and the environment sensors 104 depicted in FIG. 1. As it relates to BSM detection, the sensor data 334 includes perception data by which the capability module 344 determines the BSM capability of the nearby vehicle 100-2. As described above, the BSM system of a vehicle may include various BSM sensors and various BSM indicators placed around the body of the vehicle. Environment sensors 104 of the ego vehicle 100-1 capture data (e.g., images, LiDAR data, radar data, and sonar data, to name a few) of objects in the surrounding environment. As such, this sensor data 334 would record the presence, and in some cases activity, of the BSM sensors and indicators of the nearby vehicle 100-2.

In some examples, the sensor data 334 may capture images of the interior of the nearby vehicle 100-2. Specifically, the nearby vehicle 100-2 may include an interior indicia of BSM capability, for example, in the form of a BSM system indicator that indicates whether the BSM system of the nearby vehicle 100-2 is activated. In some examples, the ego vehicle environment sensor 104 may capture data (e.g., an image) of the inside of the nearby vehicle 100-2 to determine whether an interior BSM system indicator (i.e., an indicator that the BSM system) is active.

In one embodiment, the data store 332 stores the sensor data 334 along with, for example, metadata that characterizes various aspects of the sensor data 334. For example, the metadata can include location coordinates (e.g., longitude and latitude), relative map coordinates or tile identifiers, time/date stamps from when the separate sensor data 334 was generated, and so on.

In one embodiment, the data store 332 further includes vehicle data 336. In general, vehicle data 336 includes information about the characteristics and functionalities of various vehicles. As described, the capability module 344 may include a machine vision or image processor that extracts BSM capability from various environment sensors 104 of the ego vehicle 100-1. In an example, the extraction may be from specific regions of the perception data. For example, regions of the data that do not depict the nearby vehicle 100-2 may be disregarded during BSM detection operations. Moreover, even portions of the perception data that depict certain regions of the nearby vehicle 100-2 may be disregarded as such regions are not likely to include BSM sensors or indicators. That is to say, perception data processing may be localized to those regions of the nearby vehicle 100-2 that are most likely to include BSM sensors and indicators. These regions to be searched may be identified in the vehicle data 336. Put another way, vehicle data 336 may include, for various vehicles, 1) whether or not such vehicles contain BSM capabilities and 2) the location of the BSM components on the vehicle.

For example, vehicle data 336 for a particular make/model of a sedan may indicate that the BSM indicator 228 is in a lower left-hand quadrant of a side-view mirror. The vehicle data 336 for a different particular make/model of a sedan may indicate that the BSM indicator 228 is in an upper left-hand quadrant of the side-view mirror. As such, the vehicle data 336 may be indexed by vehicle (for example, based on the vehicle make, model, and/or year) to indicate the location of BSM sensors and indicators so that the capability module 344 may prioritize analyzing portions of the perception data associated with the indicated locations to more quickly, and potentially more accurately, depict the BSM capability of the nearby vehicle 100-2.

The BSM detection system 126 includes various modules to perform the functionality described herein. Specifically, the BSM detection system includes a capture module 342 that, in one embodiment, includes instructions that cause the processor 338 to capture perception data from an environment sensor 104 of the ego vehicle 100-1. As described above, the environment sensors 104, which may include a radar sensor 105, a LiDAR sensor 106, a sonar sensor 107, and a camera 108, among others, perceive objects in an area surrounding the ego vehicle 100-1, specifically of the nearby vehicle 100-2 and components on the nearby vehicle such as BSM sensors 230 and BSM indicators 228. Accordingly, the capture module 342 generally includes instructions that control the processor 338 to receive data inputs from one or more sensors of the ego vehicle 100-1. The inputs are, in one embodiment, observations of one or more objects in an environment proximate to the ego vehicle 100-1 and/or other aspects about the surroundings. As provided for herein, the capture module 342, in one embodiment, acquires sensor data 334 that includes at least camera images of the nearby vehicle 100-2. In further arrangements, the capture module 342 acquires the sensor data 334 from further sensors such as a radar sensor 105, a LiDAR sensor 106, and other sensors as may be suitable for identifying the nearby vehicle 100-2 and components of the nearby vehicle 100-2.

Accordingly, the capture module 342, in one embodiment, controls the respective sensors to provide the data inputs in the form of the sensor data 334. Additionally, while the capture module 342 is discussed as controlling the various sensors to provide the sensor data 334, in one or more embodiments, the capture module 342 can employ other techniques to acquire the sensor data 334 that are either active or passive. For example, the capture module 342 may passively sniff the sensor data 334 from a stream of electronic information provided by the various sensors to further components within the ego vehicle 100-1. Moreover, the capture module 342 can undertake various approaches to fuse data from multiple sensors when providing the sensor data 334. Thus, the sensor data 334, in one embodiment, represents a combination of perceptions acquired from multiple sensors.

Moreover, the capture module 342, in one embodiment, controls the sensors to acquire the sensor data 334 about an area that encompasses 360 degrees about the ego vehicle 100-1 in order to provide a comprehensive assessment of the surrounding environment. Of course, in alternative embodiments, the capture module 342 may acquire the sensor data about a forward direction alone when, for example, the ego vehicle 100-1 is not equipped with further sensors to include additional regions about the vehicle and/or the additional regions are not scanned due to other reasons (e.g., unnecessary due to known current conditions).

The BSM detection system 126 also includes a capability module 344 that includes instructions that cause the processor 338 to extract, from the perception data, a BSM capability of the nearby vehicle 100-2. As described above, the nearby vehicle 100-2 may have various indicia that it is BSM capable. Specific examples include BSM sensors 230 and BSM indicators 228 on the exterior or interior of the nearby vehicle 100-2. Accordingly, the capability module 344 includes instructions that cause the processor 338 to detect at least one of a BSM indicator 228 or a BSM sensor 230 on the nearby vehicle 100-2. For example, as described above, the BSM indicator 228 may be on the nearby vehicle 100-2 side-view mirror. In this example, the capability module 344 includes instructions that cause the processor 338 to detect a BSM indicator 228 on a side-view mirror of the nearby vehicle 100-2. If the nearby vehicle 100-2 includes these components, the BSM detection system 126 may conclude that the nearby vehicle 100-2 is BSM capable. By comparison, if the nearby vehicle 100-2 does not have these components, the BSM detection system 126 may determine that the nearby vehicle 100-2 is a non-BSM type vehicle.

To perform this detection, the capability module 344 may include a machine vision or perception data processor to analyze the perception data to identify BSM indicators 228 and BSM sensors 230 on the nearby vehicle 100-2. In general, a machine vision system is one in which a processor 338 identifies objects within an image and tracks objects through various frames. Accordingly, as described above, the capture module 342 may instruct environment sensors 104, such as RBG or infrared outwardly-facing cameras 108, to capture images or video of the surrounding environment. The capability module 344 then extracts features from the image, such as edges, textures, colors, and shapes. These features are used to identify and classify objects found within the images. For example, the capability module 344 may detect the edges of a BSM sensor 230 protruding from the bottom surface of the side-view mirror, as depicted in FIG. 2. The detection of this physical structure and the classification of the physical structure as a BSM sensor 230 indicates the BSM capability of the nearby vehicle 100-2.

As another example, the BSM indicator 228 may have a physical structure different from the side-view mirror on which it is disposed. For example, an active BSM indicator 228 may emit light having a particular color, such as orange. An inactive BSM indicator 228 may still have a distinct appearance from the rest of the side-view mirror. For example, an inactive BSM indicator 228 may be less reflective than the other portions of the side-view mirror. In these examples and others, the capability module 344 may identify and differentiate the BSM indicator 228 based on its difference from the other portions of the side-view mirror via image processing, as described above.

In one particular example, the capability module 344 includes instructions that cause the processor 338 to detect the illumination activity of the BSM indicator 228. As described above, the BSM indicator 228 illuminates when a vehicle is found within the vehicle blind spot. In this example, the ego vehicle 100-1 may detect a preceding vehicle executing a takeover maneuver of the nearby vehicle 100-2. In this case, the capability module 344 may detect the BSM capability of the nearby vehicle 100-2 based on the different states (e.g., “on” to indicate an occupied blind spot and “off” to indicate a clear blind spot) of the BSM indicator 228. Note that while particular reference is made to particular operations to detect a BSM sensor 230 and/or a BSM indicator 228, the capability module 344 may execute other operations (e.g., other perception data processing vs. image processing) to identify these or other features of the BSM system components. In any example, the capability module 344 infers the BSM capability of the nearby vehicle 100-2 based on the presence of BSM sensors 230 and BSM indicators 228 on the nearby vehicle 100-2.

In an example, the capability module 344 may be able to determine whether the BSM system of the nearby vehicle 100-2 is functioning correctly or not. For example, the capability module 344 may determine that there are BSM indicators 228 on the nearby vehicle 100-2. However, the capability module 344 may detect that the BSM indicator 228 does not illuminate when a preceding vehicle passes the nearby vehicle 100-2. In this example, an appropriate remedial measure may be executed responsive to the detected malfunctioning BSM system. In a specific example, the remedial measure for a malfunctioning BSM system may be the same as the remedial measure based on the absence of a BSM system on the nearby vehicle 100-2.

In any example, the capability module 344 may rely on a machine learning or deep learning operation to identify the BSM system components. As described herein, a machine learning algorithm includes but is not limited to neural networks such as deep neural networks (DNN), artificial neural networks (ANN), transformer networks, convolutional neural networks (CNN), recurrent neural networks (RNN), etc., Support Vector Machines (SVM), clustering algorithms, Hidden Markov Models, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the BSM detection system 126 or another system generally trains the machine learning algorithm according to a particular training approach, which may include supervised training, self-supervised training, reinforcement learning, and so on. In contrast to training/learning of the machine learning algorithm, the BSM detection system 126 implements the machine learning algorithm to perform inference. Thus, the general use of the machine learning algorithm is described as inference. In another example, the capability module 344 may perform unsupervised machine learning where objects are identified without relying on a training data set.

The BSM detection system 126 also includes a control module 346, which includes instructions that cause the processor 338 to generate a control signal for an ego vehicle 100-1 based on the BSM system capability of the nearby vehicle 100-2. Specifically, the control module 346 may generate a control signal responsive to an indication that the nearby vehicle 100-2 is a non-BSM type vehicle or that the BSM system of the nearby vehicle 100-2 is malfunctioning.

The control signal alters the operation of a driver assistance system 348 of the ego vehicle 100-1. As described above, the driver assistance system 348 may take various forms. In one example, the driver assistance system 348 generates notifications to be presented to a driver of the ego vehicle 100-1. For example, the driver assistance system 348 may generate 1) a visual notification to be presented on a GUI of the ego vehicle 100-1, 2) an audio notification to be transmitted through a speaker of the ego vehicle 100-1, and/or 3) a haptic notification to be transmitted through a steering wheel of the ego vehicle 100-1. In any example, the driver assistance system 348 may alter or take control of the operation of various vehicle output systems 124. The form of the notification may vary. For example, the notification may warn of the non-BSM type nearby vehicle 100-2 or that the nearby vehicle 100-2 BSM system is malfunctioning. In another example, the notification may provide suggested actions, such as increasing takeover speed and/or increasing lateral movement to increase visibility.

In another example, the driver assistance system 348 takes control over or alters the operation of various vehicle systems 109, in general, to reduce the amount of time that the ego vehicle 100-1 is in the blind spot of the nearby vehicle 100-2 or to increase the visibility of the ego vehicle 100-1 to the nearby vehicle 100-2. The driver assistance system 348 may alter any of the depicted vehicle systems 109 including, but not limited to, the propulsion system 110, the braking system 111, the steering system 112, the throttle system 113, the transmission system 114, the signaling system 115, and the navigation system 116. In conjunction with controlling these vehicle systems 109, the driver assistance system 348 may control the automated driving module 125. That is to say, the driver assistance system 348 may control the ego vehicle 100-1, in some cases, with limited or no input from the driver.

As a specific example, the driver assistance system 348 may control the steering system 112 to introduce lateral movement of the ego vehicle 100-1 while behind the nearby vehicle 100-2 to increase visibility. As another example, the driver assistance system 348 may control the propulsion system 110 and/or the throttle system 113 to increase the speed of the ego vehicle 100-1 during a takeover maneuver. While particular reference is made to particular safety-enhancing operations, the driver assistance system 348 may execute any number of these or other operations of the ego vehicle 100-1. The BSM detection system 126 generates the control signals that alter the operation of the vehicle systems 109 and transmits such to the driver assistance system 348 such that control of the vehicle systems 109 is controlled based on a detected BSM capability of the nearby vehicle 100-2.

Accordingly, the BSM detection system 126 enhances driver assistance systems 348 by increasing the autonomous control and feedback triggers and the control capabilities of the driver assistance systems 348. That is, the BSM detection system 126 of the present specification increases the quantity of potentially dangerous circumstances that are protected against and increases the ways and types of control over the ego vehicle 100-1.

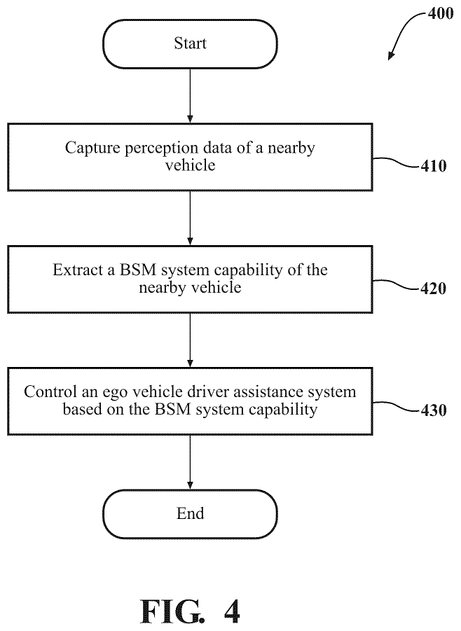

Additional aspects of controlling an ego vehicle 100-1 responsive to a detected BSM capability of a nearby vehicle 100-2 will be discussed in relation to FIG. 4. FIG. 4 illustrates a flowchart of a method 400 that is associated with detecting the BSM capability of a nearby vehicle 100-2. Method 400 will be discussed from the perspective of the BSM detection system 126 of FIG. 1, and 2. While method 400 is discussed in combination with the BSM detection system 126, it should be appreciated that the method 400 is not limited to being implemented within the BSM detection system 126 but is instead one example of a system that may implement the method 400.

At 410, the capture module 342 controls the sensor system 102 to capture perception data from an environment sensor 104 of an ego vehicle 100-1, which environment sensor 104 perceives objects in an area surrounding the ego vehicle 100-1. In one embodiment, the capture module 342 controls an outwardly-facing camera 108 of the vehicle 100 to observe the surrounding environment. Alternatively, or additionally, the capture module 342 controls the camera 108, LiDAR sensor 106, radar sensor 105, and others to acquire the perception data, which is an example of sensor data 334. As part of controlling the sensors to acquire the perception data, it may be that the sensors acquire the perception data of a region around the ego vehicle 100-1, with data acquired from different types of sensors generally overlapping in order to provide for a comprehensive sampling of the surrounding environment at each time step. Thus, the capture module 342, in one embodiment, controls the sensors to acquire the perception data of the surrounding environment.

Moreover, in further embodiments, the capture module 342 controls the sensors to acquire the perception data at successive iterations or time steps. Thus, the BSM detection system 126, in one embodiment, iteratively executes the functions discussed at blocks 410-420 to acquire the perception data and provide information therefrom. Furthermore, the capture module 342, in one embodiment, executes one or more of the noted functions in parallel for separate observations in order to maintain updated perceptions. Additionally, as previously noted, the capture module 342, when acquiring data from multiple sensors, fuses the data together to form the perception data and to provide for improved determinations of detection, location, and so on.

At 420, the capability module 344 extracts, from the perception data, a BSM system capability of the nearby vehicle 100-2. Specifically, the capability module 344 analyzes the perception data via machine vision, image processing, or other sensor processing operations to detect BSM sensors 230 and/or BSM indicators 228 in the captured perception data. The presence and detection of these BSM sensors 230 and BSM indicators 228 indicate that the nearby vehicle 100-2 is BSM capable. By comparison, the absence of these BSM sensors 230 and BSM indicators 228 indicates that the nearby vehicle 100-2 is a non-BSM type vehicle. At this stage, the capability module 344 may indicate 1) that the nearby vehicle 100-2 includes a properly functioning BSM system, 2) that the nearby vehicle 100-2 includes a malfunctioning BSM system, and/or 3) that the nearby vehicle 100-2 does not include a BSM system.

The capability module 344 may determine that the nearby vehicle 100-2 includes a functioning BSM system by identifying BSM sensors 230 and BSM indicators 228 in the perception data and identifying that the BSM indicators 228 are appropriately responding (e.g., flashing) when preceding vehicles pass the nearby vehicle 100-2. The capability module 344 may determine that the BSM system of the nearby vehicle 100-2 is malfunctioning by identifying BSM sensors 230 and BSM indicators 228 in the perception data and identifying that the BSM indicators 228 are not activating when preceding vehicles pass the nearby vehicle 100-2. The capability module 344 may determine that the nearby vehicle 100-2 is a non-BSM type vehicle when no BSM sensor 230 or BSM indicator 228 is detected in the perception data.

In any case, at 430, the control module 346 generates a control signal for the ego vehicle 100-1 based on the BSM system capability of the nearby vehicle 100-2. Specifically, the control module 346 may generate a control signal responsive to an indication that the BSM system of the nearby vehicle 100-2 is malfunctioning or that the nearby vehicle 100-2 is a non-BSM type vehicle. The control signal alters the operation of a driver assistance system 348 of the ego vehicle 100-1. For example, as described above, the control signal may control an output system 124 (e.g., a display device, a speaker, or a haptic feedback device) of the vehicle to generate a notification to the driver of the ego vehicle 100-1, which notification may or may not include recommended actions.

In another example, the control signal may control a vehicle system 109 or automated driving module 125 of the ego vehicle 100-1. Specifically, the control signal may adjust the braking, acceleration, and/or steering commands of an automated driving module 125 based on the detected BSM capability of the nearby vehicle 100-2. Example vehicle system operations include inducing cyclic lateral movements to increase ego vehicle 100-1 visibility, increasing speed during a takeover maneuver to reduce the time the ego vehicle 100-1 is in the nearby vehicle 100-2 blind spot, and increasing a takeover berth to increase a distance between the nearby vehicle 100-2 and the ego vehicle 100-1. However, other vehicle system control operations may be performed to increase driver and vehicle safety. In any of these examples, the control signal is transmitted to a driver assistance system 348, which may alter the operation of the output system 124, automated driving module 125, and/or various vehicle systems 109.

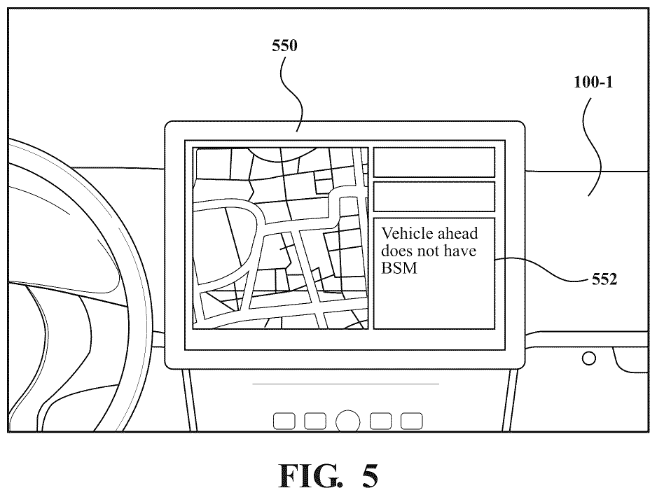

FIG. 5 illustrates a notification 552, which indicates the BSM capability of a nearby vehicle 100-2. As described above, the control module 346 may include instructions that cause the processor 338 to generate and transmit a notification 552 to be presented in a cabin of the ego vehicle 100-1, which notification 552 indicates the BSM system capability of the nearby vehicle 100-2. In the example depicted in FIG. 5, the ego vehicle 100-1 may include a GUI 550 on which information such as navigational instructions, radio information, etc., may be presented. In one example, the control module 346 may overlay or replace a portion of the presentation area of the GUI 550 with a notification 552 that indicates the BSM capability of the nearby vehicle 100-2 as determined by the BSM detection system 126. As described above, the notification may be that the BSM system of the nearby vehicle 100-2 is malfunctioning, that the nearby vehicle 100-2 is a non-BSM type vehicle, or that the BSM system of the nearby vehicle 100-2 is functioning as expected and that the driver may proceed without any extra safety measures. While particular reference is made to a particular type of notification 552 (i.e., visual) with particular content. As described above, the type and content of the notification may vary.

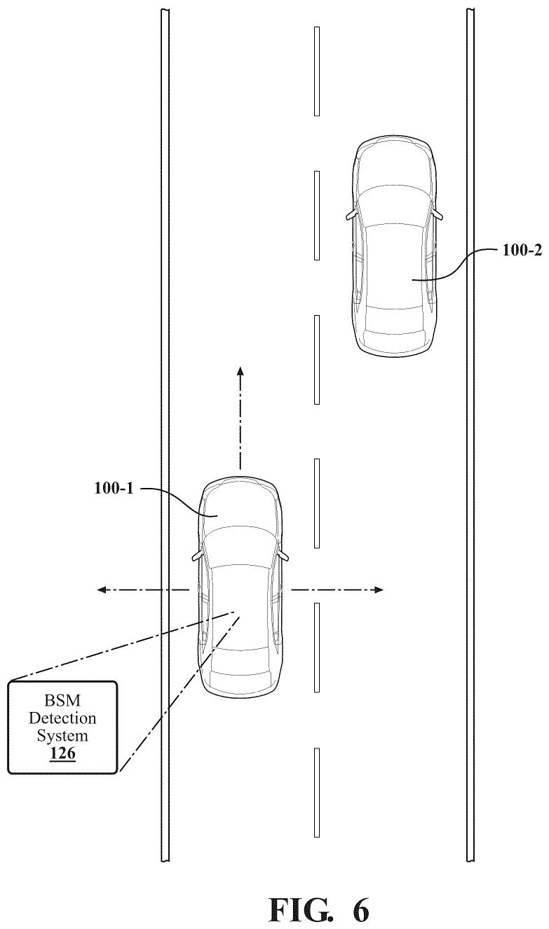

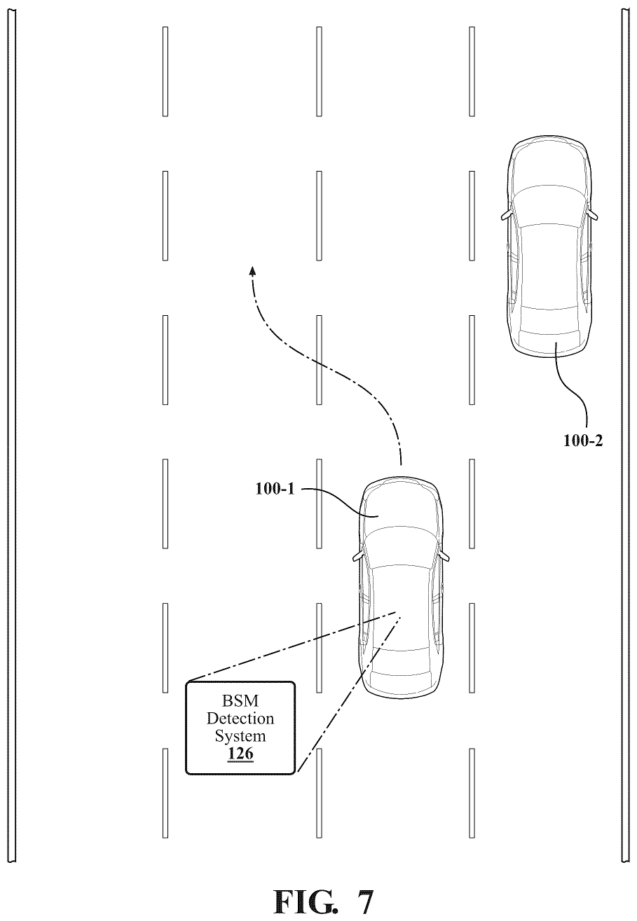

FIG. 6 illustrates the BSM detection system 126 altering the movement of an ego vehicle 100-1 based on the BSM capability of a nearby vehicle 100-2. As described above, the control module 346 may include instructions that cause the processor 338 to generate a control signal that alters the movement of the ego vehicle 100-1 when the nearby vehicle 100-2 is a non-BSM type vehicle or when the BSM system of the nearby vehicle 100-2 is malfunctioning. For example, the ego vehicle 100-1 may be at least partially controlled by an automated driving module 125, which operates the various vehicle systems 109 in an automated fashion. In this example, the control signal generated by the control module 346 and executed by the driver assistance system 348 may alter how the automated driving module 125 operates the various vehicle systems. The control may be altered to 1) increase the visibility of the ego vehicle 100-1 and/or 2) reduce the amount of time that the ego vehicle 100-1 is in the nearby vehicle 100-2 blind spot. FIGS. 6 and 7 depict various examples of vehicle controls that may be performed. Specifically, as depicted in FIG. 6, the control module 346 may induce a lateral side-to-side movement of the ego vehicle 100-1 by controlling the steering system 112 of the ego vehicle 100-1. The control module 346 may also increase the longitudinal speed of the ego vehicle 100-1 during the takeover by controlling the propulsion system 110 and the throttle system 113.

As depicted in FIG. 7, the control module 346 may increase the spacing between the ego vehicle 100-1 and the nearby vehicle 100-2 (i.e., increase a takeover berth) during the takeover by controlling the steering system 112 of the ego vehicle 100-1. For example, rather than passing the nearby vehicle 100-2 in the immediately adjacent lane, the control module 346 may direct the steering system 112 to operate to move the ego vehicle 100-1 to a spaced apart lane.

In some examples, the BSM detection system 126 may execute these or other control operations to decrease the likelihood of an undesirable vehicle interaction. Accordingly, the BSM detection system 126 increases passenger and roadway safety.

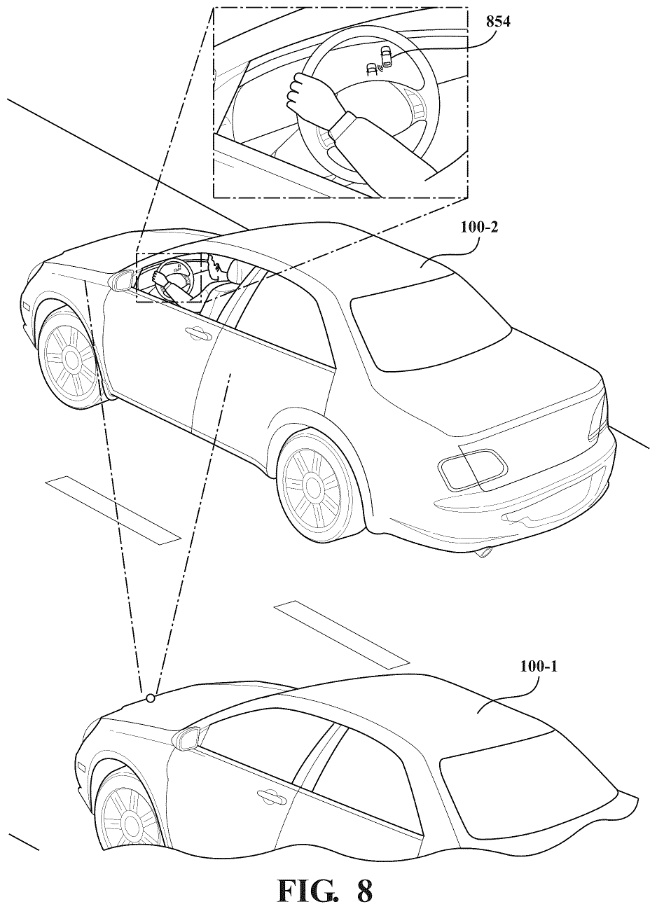

FIG. 8 illustrates a BSM detection system 126 detecting the BSM capability of a nearby vehicle 100-2. As described above, the BSM detection system 126 may analyze images of the exterior of the nearby vehicle 100-2 to determine the BSM capability of the nearby vehicle 100-2. This may happen while the ego vehicle 100-1 is behind the nearby vehicle 100-2, as depicted in FIGS. 2, 6, and 7. However, in some examples, the BSM detection system 126 may not be able to definitively detect the BSM capability with a threshold level of confidence. For example, the capability module 344 may not conclusively identify the BSM sensors 230 and/or BSM indicators 228. In this example, the control module 346 may generate a notification indicating such (i.e., that it is unclear whether the nearby vehicle 100-2 has a BSM system and, therefore that is unclear whether the driver of the nearby vehicle 100-2 is aware of the ego vehicle 100-1) and recommended that appropriate precautions be taken. In the example of automated control of the ego vehicle 100-1, the control module 346 may induce the same control operations described above or different operations to ensure driver safety.

Still in this example, the BSM detection system 126 may rely on additional perception data collected as the ego vehicle 100-1 passes the nearby vehicle 100-2 to determine the BSM capability of the nearby vehicle 100-2. For example, while passing the nearby vehicle 100-2, the environment sensors 104 may collect data about the nearby vehicle 100-2 cabin. Specifically, some vehicles may include instrument panel indicators of the status of various systems, including a BSM system. Accordingly, while passing the nearby vehicle 100-2, the environment sensors 104 (e.g., a camera) may capture perception data of the nearby vehicle 100-2 cabin. Using image processing, machine vision, or other sensor processing as described above, the capability module 344 may detect whether a BSM system indicator 854 in the nearby vehicle 100-2, for example, on the instrument panel of the nearby vehicle 100-2, is illuminated. When illuminated, the instrument panel BSM system indicator 854 may indicate that the nearby vehicle 100-2 BSM system is active. Accordingly, the BSM detection system 126 may use the presence or lack of a BSM system indicator 854 and/or the illumination of the BSM system indicator 854 to determine the BSM capability of the nearby vehicle 100-2.

For example, the lack of a BSM system indicator 854 or a BSM system indicator 854 that is not illuminated may indicate that the nearby vehicle 100-2 is a non-BSM type vehicle or that the BSM system of the nearby vehicle 100-2 has been turned off. Either of these cases may trigger the safety-enhancing countermeasures described above. By comparison, if the BSM system indicator 854 on the inside of the nearby vehicle 100-2 is illuminated, it may confirm the exterior sensor/indicator-based indication of BSM capability or provide supporting indicia that the nearby vehicle 100-2 is BSM capable.

In another example, the identification of the BSM system indicator 854 in the perception data may facilitate an indication that the BSM system of the nearby vehicle 100-2 is malfunctioning. For example, if the capability module 344 does not detect an illuminated BSM indicator 228 as a preceding vehicle passes the nearby vehicle but detects an illuminated BSM system indicator 854 on the interior of the nearby vehicle 100-2, the capability module 344 may determine that the BSM system of the nearby vehicle is malfunctioning. Appropriate remedial measures may then be executed. In any case, the capability module 344 may include instructions that cause the processor 338 to extract the BSM system capability of the nearby vehicle 100-2 based on perception data of the nearby vehicle 100-2 cabin.

Note that in-cabin BSM system status indicia may not be relied on to control the operation/notification to the ego vehicle 100-1 as the ego vehicle 100-1 may already be out of the blind spot of the nearby vehicle 100-2 when the additional perception data is collected. However, this information may be transmitted to other vehicles in the vicinity of the ego vehicle 100-1 that are similarly attempting to discover the BSM capability of the nearby vehicle 100-2.

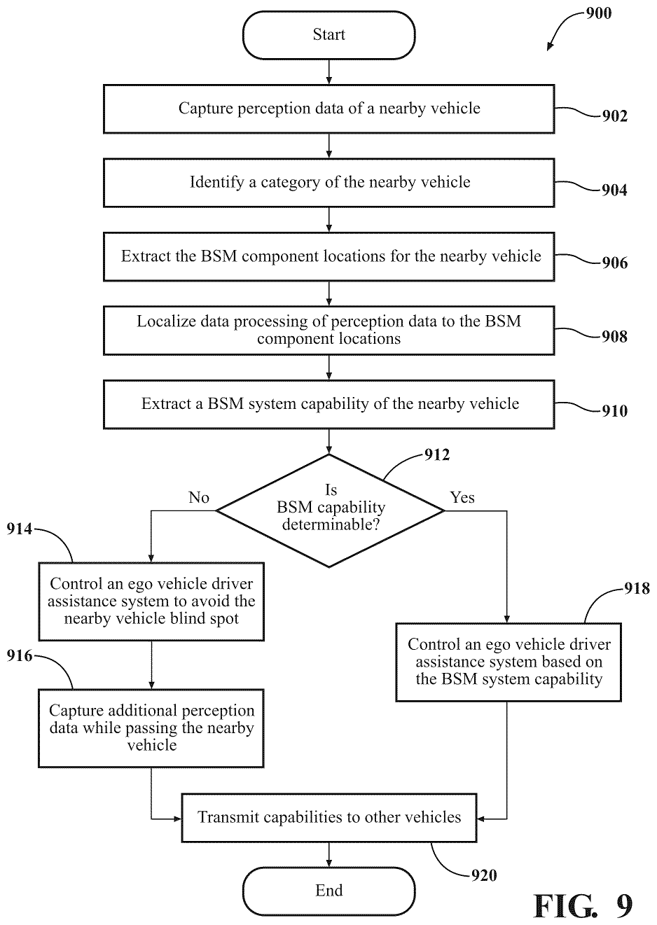

FIG. 9 illustrates a flowchart for one embodiment of a method 900 that is associated with detecting the BSM capability of a nearby vehicle 100-2.

As described above, at 902, the capture module 342 of the BSM detection system 126 controls the environment sensors 104 to capture perception data of the environment surrounding the ego vehicle 100-1, particularly of a nearby vehicle 100-2.

At 904, the capability module 344 causes the processor 338 to identify, from the perception data, a category of the nearby vehicle 100-2. In an example, the category of the nearby vehicle 100-2 may include a type of vehicle (e.g., truck, sport utility vehicle, sedan, etc.). In another example, the category of the nearby vehicle 100-2 may be the make, model, and year of the vehicle. In other examples, the nearby vehicle 100-2 may be categorized based on other criteria. In any example, the category of the nearby vehicle 100-2 may enhance the efficiency and accuracy of BSM capability detection. For example, as described above, BSM capability may be determined based on the category (e.g., make, model, year) of the nearby vehicle 100-2. As another example, the location of the BSM components (e.g., the BSM sensors 230 and the BSM indicators 228) may be specific to the vehicle category. In this later example, by identifying the category of the nearby vehicle 100-2, the capability module 344 may enhance the efficiency of BSM capability detection by localizing the data processing to targeted locations in the perception data. For example, rather than scouring an entire image from an outwardly-facing camera 108, the capability module 344 may be able to analyze a portion of the image where the BSM components are located on a particular vehicle.

Accordingly, at 906, the capability module 344 may cause the processor 338 to extract, from a vehicle record for the category of the nearby vehicle 100-2, a location of at least one of a BSM indicator 228 or a BSM sensor 230 on the nearby vehicle 100-2. For example, the vehicle record, which may be stored as vehicle data 336 in the data store 332 or received from a remote storage device, may indicate that the BSM sensor 230 for the nearby vehicle 100-2 is located on a driverside panel of the body of the nearby vehicle 100-2 and that the BSM indicator 228 is located on a lower righthand corner of a side-view mirror. Accordingly, rather than analyzing the entire image, the capability module 344, at 908, may localize the data processing of the perception data to the location indicated in the vehicle record. As described above, this increases the efficiency of detecting the BSM capability of the nearby vehicle 100-2 by reducing the workload of the capability module 344 and freeing up bandwidth for other operations.

As described above, at 910, the control module 346 may extract a BSM system capability of the nearby vehicle 100-2 based in part on the perception data of the nearby vehicle 100-2 exterior. However, in some examples as described above, the capability module 344 may not be able to accurately and reliably determine BSM capability from the exterior characteristics of the nearby vehicle 100-2 alone. For example, during low-light conditions or bad weather, the perception data may be grainy, noisy, or otherwise in a state where the machine vision, image processing, or data processing by the capability module 344 cannot clearly detect the BSM components.

Accordingly, at 912, the BSM detection system 126 determines whether the nearby vehicle's 100-2 BSM capability may be reliably determined. If so, at 918, the control module 346 may control an ego vehicle driver assistance system 348 based on the BSM system capability. As described above, this may include generating a notification or controlling the ego vehicle 100-1 movement to increase visibility or decrease the amount of time that the ego vehicle 100-1 spends in the blind spot of the nearby vehicle 100-2 when the nearby vehicle 100-2 is determined to be a non-BSM type vehicle or that the BSM system of the nearby vehicle 100-2 is malfunctioning.

If the BSM capability is not determinable based on data captured of the exterior of the nearby vehicle 100-2, at 914, the control module 346 may control the ego vehicle driver assistance system 348 to avoid the blind spot. That is, in the case that the output of the capability module 344 is indeterminate based on the analysis of perception data of the exterior of the nearby vehicle 100-2, the control module 346 may operate the ego vehicle 100-1 in a particular manner to promote the safety of the passengers and vehicles. Specifically, the control module 346 may operate the ego vehicle 100-1 using the same controls described above to increase the visibility of the ego vehicle 100-1 and decrease the amount of time the ego vehicle 100-1 is in the blind spot of the nearby vehicle 100-2. Specifically, the control module 346 may generate a notification and/or control a movement of the ego vehicle 100-1.

At 916, the capture module 342 may control the sensors to capture additional perception data as the ego vehicle 100-1 passes the nearby vehicle 100-2. For example, the outwardly-facing camera 108, or another camera, may capture images of the cabin of the nearby vehicle 100-2. In a similar fashion, the image of the interior cabin may be analyzed to determine whether a BSM system indicator 854 is illuminated in the cabin of the nearby vehicle 100-2. Based on this additional information, the capability module 344 may determine or confirm the BSM capability status of the nearby vehicle 100-2.

In either example (i.e., the perception data of the exterior of the nearby vehicle 100-2 is or is not reliable), at 920, the BSM detection system 126, using the communications system 127 may cause the processor 338 to communicate the BSM system capability of the nearby vehicle 100-2 to another vehicle. That is, just as the ego vehicle 100-1 determines the BSM capability of the nearby vehicle 100-2 to control its operation, other vehicles in the region may similarly attempt to determine the BSM capability of the nearby vehicle 100-2. In this example, the determination made by the ego vehicle 100-1 may be transmitted to another vehicle. Responsive to this transmission, the other vehicle may take similar precautions as the ego vehicle 100-1.

In this way, the disclosed systems, methods, and other embodiments improve vehicle driver assistance systems. For example, the present system expands the capability of driver assistance systems by providing new detection functionality by detecting whether a nearby vehicle has an active and functioning BSM detection system. In particular, the BSM detection is a non-communications-based system that does not rely on the nearby and ego vehicle sharing a communications network. As described above, such a BSM detection system responds to a potential risk that may previously have gone undetected, that of an ego vehicle driver incorrectly assuming a nearby vehicle driver is cognizant of their presence. Accordingly, the current BSM detection system increases the breadth of protection offered by driver assistance systems and increases vehicle operation safety.

The current system also enhances driver assistance by introducing a new vehicle control trigger (e.g., whether or not the nearby vehicle has blind spot sensing capability), new sensing capabilities (e.g., sensing whether the nearby vehicle has BSM sensors and indicators), and a new control paradigm (e.g., generating notifications and altering vehicle operation based on the BSM capability of a nearby vehicle). Still further, the present system alters the feedback systems of the ego vehicle by providing new feedback modalities, specifically those that indicate the status of nearby vehicles, where previously vehicle BSM state-based notifications may not be implemented.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 101. In one or more arrangements, the processor(s) 101 can be a primary/centralized processor of the vehicle 100 or may be representative of many distributed processing units. For instance, the processor(s) 101 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 100.

The vehicle 100 can include one or more data stores 118 for storing one or more types of data. The data store 118 can be comprised of volatile and/or non-volatile memory. Examples of memory that may form the data store 118 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 118 is a component of the processor(s) 101. In general, the data store 118 is operatively connected to the processor(s) 101 for use thereby. The term “operatively connected,” as used throughout this description, can include direct or indirect connections, including connections without direct physical contact.

In one or more arrangements, the one or more data stores 118 include various data elements to support functions of the vehicle 100, such as semi-autonomous and/or autonomous functions. Thus, the data store 118 may store map data 119 and/or sensor data 122. The map data 119 includes, in at least one approach, maps of one or more geographic areas. In some instances, the map data 119 can include information about roads (e.g., lane and/or road maps), traffic control devices, road markings, structures, features, and/or landmarks in the one or more geographic areas. The map data 119 may be characterized, in at least one approach, as a high-definition (HD) map that provides information for autonomous and/or semi-autonomous functions.

In one or more arrangements, the map data 119 can include one or more terrain maps 120. The terrain map(s) 120 can include information about the ground, terrain, roads, surfaces, and/or other features of one or more geographic areas. The terrain map(s) 120 can include elevation data in the one or more geographic areas. In one or more arrangements, the map data 119 includes one or more static obstacle maps 121. The static obstacle map(s) 121 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 122 is data provided from one or more sensors of the sensor system 102. Thus, the sensor data 122 may include observations of a surrounding environment of the vehicle 100 and/or information about the vehicle 100 itself. In some instances, one or more data stores 118 located onboard the vehicle 100 store at least a portion of the map data 119 and/or the sensor data 122. Alternatively, or in addition, at least a portion of the map data 119 and/or the sensor data 122 can be located in one or more data stores 118 that are located remotely from the vehicle 100.

As noted above, the vehicle 100 can include the sensor system 102. The sensor system 102 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 102 and/or the one or more sensors can be operatively connected to the processor(s) 101, the data store(s) 118, and/or another element of the vehicle 100.

Various examples of different types of sensors will be described herein. However, it will be understood that the embodiments are not limited to the particular sensors described. In various configurations, the sensor system 102 includes one or more vehicle sensors 103 and/or one or more environment sensors. The vehicle sensor(s) 103 function to sense information about the vehicle 100 itself. In one or more arrangements, the vehicle sensor(s) 103 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 102 can include one or more environment sensors 104 that sense a surrounding environment (e.g., external) of the vehicle 100 and/or, in at least one arrangement, an environment of a passenger cabin of the vehicle 100. For example, the one or more environment sensors 104 sense objects the surrounding environment of the vehicle 100. Such obstacles may be stationary objects and/or dynamic objects. Various examples of sensors of the sensor system 102 will be described herein. The example sensors may be part of the one or more environment sensors 104 and/or the one or more vehicle sensors 103. However, it will be understood that the embodiments are not limited to the particular sensors described. As an example, in one or more arrangements, the sensor system 102 includes one or more radar sensors 105, one or more LiDAR sensors 106, one or more sonar sensors 107 (e.g., ultrasonic sensors), and/or one or more cameras 108 (e.g., monocular, stereoscopic, RGB, infrared, etc.).

Continuing with the discussion of elements from FIG. 1, the vehicle 100 can include an input system 123. The input system 123 generally encompasses one or more devices that enable the acquisition of information by a machine from an outside source, such as an operator. The input system 123 can receive an input from a vehicle passenger (e.g., a driver/operator and/or a passenger). Additionally, in at least one configuration, the vehicle 100 includes an output system 124. The output system 124 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 109. Various examples of the one or more vehicle systems 109 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 110, a braking system 111, a steering system 112, a throttle system 113, a transmission system 114, a signaling system 115, and a navigation system 116.

The navigation system 116 can include one or more devices, applications, and/or combinations thereof to determine the geographic location of the vehicle 100 and/or to determine a travel route for the vehicle 100. The navigation system 116 can include one or more mapping applications to determine a travel route for the vehicle 100 according to, for example, the map data 119. The navigation system 116 may include or at least provide connection to a global positioning system, a local positioning system or a geolocation system.

In one or more configurations, the vehicle systems 109 function cooperatively with other components of the vehicle 100. For example, the processor(s) 101, the BSM detection system 126, and/or automated driving module(s) 125 can be operatively connected to communicate with the various vehicle systems 109 and/or individual components thereof. For example, the processor(s) 101 and/or the automated driving module(s) 125 can be in communication to send and/or receive information from the various vehicle systems 109 to control the navigation and/or maneuvering of the vehicle 100. The processor(s) 101, the BSM detection system 126, and/or the automated driving module(s) 125 may control some or all of these vehicle systems 109.

For example, when operating in the autonomous mode, the processor(s) 101, the BSM detection system 126, and/or the automated driving module(s) 125 control the heading and speed of the vehicle 100. The processor(s) 101, the BSM detection system 126, and/or the automated driving module(s) 125 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 117 in at least one configuration. The actuators 117 are, for example, elements operable to move and/or control a mechanism, such as one or more of the vehicle systems 109 or components thereof responsive to electronic signals or other inputs from the processor(s) 101 and/or the automated driving module(s) 125. The one or more actuators 117 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 101, implement one or more of the various functions described herein. In various arrangements, one or more of the modules are a component of the processor(s) 101, or one or more of the modules are executed on and/or distributed among other processing systems to which the processor(s) 101 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 125. The automated driving module(s) 125, in at least one approach, receive data from the sensor system 102 and/or other systems associated with the vehicle 100. In one or more arrangements, the automated driving module(s) 125 use such data to perceive a surrounding environment of the vehicle. The automated driving module(s) 125 determine a position of the vehicle 100 in the surrounding environment and map aspects of the surrounding environment. For example, the automated driving module(s) 125 determines the location of obstacles or other environmental features including traffic signs, trees, shrubs, neighboring vehicles, pedestrians, etc.

The automated driving module(s) 125, either independently or in combination with the BSM detection system 126, can be configured to determine travel path(s), current autonomous driving maneuvers for the vehicle 100, future autonomous driving maneuvers and/or modifications to current autonomous driving maneuvers based on data acquired by the sensor system 102 and/or another source. In general, the automated driving module(s) 125 functions to, for example, implement different levels of automation, including advanced driving assistance (ADAS) functions, semi-autonomous functions, and fully autonomous functions, as previously described.

Moreover, the vehicle 100 functions in cooperation with a communication system 127. In one embodiment, the communication system 127 communicates according to one or more communication standards. For example, the communication system 127 can include multiple different antennas/transceivers and/or other hardware elements for communicating at different frequencies and according to respective protocols. The communication system 127, in one arrangement, communicates via a communication protocol, such as a WiFi, dedicated short-range communication (DSRC), vehicle-to-infrastructure (V2I), vehicle-to-vehicle (V2V), or another suitable protocol for communicating between the vehicle 100 and other entities in the cloud environment. Moreover, the communication system 127, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the BSM detection system 126 can leverage various wireless communication technologies to provide communications to other entities, such as members of the cloud-computing environment.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
capture perception data from an environment sensor of an ego vehicle, the environment sensor perceives objects in an area surrounding the ego vehicle;
extract, from the perception data, a blind spot monitoring (BSM) capability of a nearby vehicle; and
generate a control signal for the ego vehicle based on the BSM capability of the nearby vehicle, the control signal alters an operation of a driver assistance system of the ego vehicle.

2. The system of claim 1, wherein the machine-readable instruction that causes the processor to generate the control signal for the ego vehicle comprises a machine-readable instruction that causes the processor to generate and transmit a notification to be presented in a cabin of the ego vehicle, the notification indicates the BSM capability of the nearby vehicle.

3. The system of claim 1, wherein the machine-readable instruction that causes the processor to extract the BSM capability of the nearby vehicle comprises a machine-readable instruction that causes the processor to determine that the nearby vehicle is a non-BSM type vehicle.

4. The system of claim 1, wherein the machine-readable instruction that causes the processor to generate the control signal for the ego vehicle comprises a machine-readable instruction that causes the processor to generate the control signal to alter a movement of the ego vehicle.

5. The system of claim 1, wherein the machine-readable instruction that causes the processor to extract the BSM capability of the nearby vehicle comprises a machine-readable instruction that causes the processor to detect at least one of a BSM indicator or a BSM sensor on the nearby vehicle.

6. The system of claim 5, wherein the machine-readable instruction that causes the processor to detect at least one of the BSM indicator or the BSM sensor on the nearby vehicle comprises a machine-readable instruction that causes the processor to detect the BSM indicator on a side-view mirror of the nearby vehicle.

7. The system of claim 5, wherein the machine-readable instruction that causes the processor to detect at least one of the BSM indicator or the BSM sensor on the nearby vehicle comprises a machine-readable instruction that causes the processor to detect illumination activity of the BSM indicator.

8. The system of claim 1, wherein the memory further comprises machine-readable instructions that, when executed by the processor, cause the processor to:
identify, from the perception data, a category of the nearby vehicle;
extract, from a vehicle record for the category of the nearby vehicle, a location of at least one of a BSM indicator or a BSM sensor on the nearby vehicle; and
localize data processing of the perception data to the location indicated in the vehicle record.

9. The system of claim 1, wherein the memory further comprises a machine-readable instruction that, when executed by the processor, causes the processor to communicate the BSM capability of the nearby vehicle to another vehicle.

10. The system of claim 1, wherein the memory further comprises a machine-readable instruction that, when executed by the processor, causes the processor to extract the BSM capability of the nearby vehicle based on perception data of a cabin of the nearby vehicle.

11. A non-transitory computer-readable medium comprising instructions that, when executed by a processor, cause the processor to:
capture perception data from an environment sensor of an ego vehicle, the environment sensor perceives objects in an area surrounding the ego vehicle;
extract, from the perception data, a blind spot monitoring (BSM) capability of a nearby vehicle; and
generate a control signal for the ego vehicle based on the BSM capability of the nearby vehicle, the control signal alters an operation of a driver assistance system of the ego vehicle.

12. The non-transitory computer-readable medium of claim 11, wherein the instruction that causes the processor to generate the control signal for the ego vehicle comprises an instruction that causes the processor to generate and transmit a notification to be presented in a cabin of the ego vehicle, the notification indicates the BSM capability of the nearby vehicle.

13. The non-transitory computer-readable medium of claim 11, wherein the instruction that causes the processor to generate the control signal for the ego vehicle comprises an instruction that causes the processor to generate the control signal to alter a movement of the ego vehicle to:
increase a visibility of the ego vehicle; or
reduce an amount of time the ego vehicle is in a blind spot of the nearby vehicle.

14. The non-transitory computer-readable medium of claim 11, wherein the instruction that causes the processor to extract the BSM capability of the nearby vehicle comprises an instruction that causes the processor to detect at least one of a BSM indicator or a BSM sensor on the nearby vehicle.

15. The non-transitory computer-readable medium of claim 11, wherein the non-transitory computer-readable medium further comprises instructions that, when executed by the processor, cause the processor to:
identify, from the perception data, a category of the nearby vehicle;
extract, from a vehicle record for the category of the nearby vehicle, a location of at least one of a BSM indicator or a BSM sensor on the nearby vehicle; and
localize data processing of the perception data to the location indicated in the vehicle record.

16. A method, comprising:
capturing perception data from an environment sensor of an ego vehicle, the environment sensor perceives objects in an area surrounding the ego vehicle;
extracting, from the perception data, a blind spot monitoring (BSM) capability of a nearby vehicle; and
generating a control signal for the ego vehicle based on the BSM capability of the nearby vehicle, the control signal alters an operation of a driver assistance system of the ego vehicle.

17. The method of claim 16, wherein generating the control signal for the ego vehicle comprises generating and transmitting a notification to be presented in a cabin of the ego vehicle, the notification indicates the BSM capability of the nearby vehicle.

18. The method of claim 16, wherein extracting the BSM capability of the nearby vehicle comprises determining that the nearby vehicle is a non-BSM type vehicle.

19. The method of claim 16, wherein generating the control signal for the ego vehicle comprises generating the control signal to alter a movement of the ego vehicle to:
increase a visibility of the ego vehicle; or
reduce an amount of time the ego vehicle is in a blind spot of the nearby vehicle.

20. The method of claim 16, wherein the method further comprises:
identifying, from the perception data, a category of the nearby vehicle;
extracting, from a vehicle record for the category of the nearby vehicle, a location of at least one of a BSM indicator or a BSM sensor on the nearby vehicle; and
localizing data processing of the perception data to the location indicated in the vehicle record.
